(19) United States
(12) Patent Application Publication
(10) Pub. No.: US 2019/0033481 A1
(43) Pub. Date: Jan. 31, 2019

(54) PROXIMITY SENSOR APPARATUS AND ROBOT ARM MECHANISM

(71) Applicant: LIFE ROBOTICS INC., Tokyo (JP)

(72) Inventor: Kazuki IIDA, Tokyo (JP)

(21) Appl. No.: 16/147,259

(22) Filed: Sep. 28, 2018

Related U.S. Application Data
(63) Continuation of application No. PCT/JP2017/012211, filed on Mar. 26, 2017.

(30) Foreign Application Priority Data
Mar. 29, 2016 (JP) 2016-066896

(51) Int. Cl. G01V 3/08; B25J 19/02; B25J 19/06

(52) U.S. Cl. CPC G01V 3/08; B25J 19/06; B25J 19/02

(57) ABSTRACT

Provided is a proximity sensor apparatus suitable for a robot arm mechanism, and having a simple structure and a wide detection region. The proximity sensor apparatus according to the present embodiment includes a detection electrode that forms an electrostatic capacitance between the detection electrode and an object to be detected that approaches the detection electrode, a detection section that detects the electrostatic capacitance, and a determination section that determines approach of the object to be detected to the detection electrode based on the detected electrostatic capacitance, and the detection electrode includes a base that curves into a U-shape or a C-shape, the detection electrode that is disposed on a front surface of the base, and curves along the front surface of the base, and a guard that is disposed on a back surface of the base, and curves along the back surface of the base.

### CROSS-REFERENCE TO RELATED APPLICATIONS

This application is continuation application of International Patent Application No. PCT/JP2017/012211 filed on Mar. 26, 2017, which is based upon and claims the benefit of priority from the prior Japanese Patent. Application No. 2016-066896, filed Mar. 29, 2016 the entire contents of which are incorporated herein by reference.

### FIELD

Embodiments described herein relate generally to a proximity sensor apparatus and a robot arm mechanism.

### BACKGROUND

Conventionally, an articulated robot arm mechanism has been used in various fields such as an industrial robot. A linear extension and retraction mechanism that has been put to practical use by the inventors can eliminate the need for an elbow joint from a vertical-articulated-type robot arm mechanism, and eliminates the need for a safety fence to make it possible to install a robot in the vicinity of a worker, and an environment in which robots and workers cooperate with one another has become realistic.

On the other hand, it is important to secure high safety since robot arm mechanisms are disposed in the vicinity of the workers. Consequently, many robots are each equipped with a proximity sensor for each movable section. A proximity sensor has a relatively short sensitivity distance, so that in order to decrease a nonsensitive region, a large number of proximity sensors have been required with positions and sensitivity directions changed.

### CITATION LIST

### Patent Literature

[Patent Literature 1] Japanese Patent No. 5435679

### SUMMARY OF INVENTION

### Technical Problem

An object of the present invention is to provide a proximity sensor apparatus suitable for a robot arm mechanism, and having a simple structure and a large detection region.

### Solution to Problem

A proximity sensor apparatus according to a present embodiment includes a detection electrode that forms an electrostatic capacitance between the detection electrode and an object to be detected that approaches the detection electrode, a detection section that detects the electrostatic capacitance, and a determination section that determines approach of the object to be detected to the detection electrode based on the detected electrostatic capacitance, wherein the detection electrode includes a base that curves into a U-shape or a C-shape, the detection electrode that is disposed on a front surface of the base, and curves along the front surface of the base, and a guard that is disposed on a back surface of the base, and curves along the back surface of the base.

### BRIEF DESCRIPTION OF THE VIEWS OF THE DRAWING

FIG. 1 is a perspective view illustrating an external view of a robot arm mechanism according to a present embodiment;

FIG. 2 is a side view of the robot arm mechanism in FIG. 1;

FIG. 3 is a view illustrating an internal structure of the robot arm mechanism in FIG. 1;

FIG. 4 is a diagram illustrating the structure of the robot arm mechanism in FIG. 1 by graphic symbol expression;

FIGS. 5A and 5B are views showing a sensor main body of a proximity sensor apparatus in FIG. 1;

FIG. 6 is a view showing an internal structure of the sensor main body in FIGS. 5A and 5B;

FIGS. 7A, 7B, 7C, 7D, and 7E are diagrams showing a detection electrode in FIG. 6;

FIGS. 8A, 8B, and 8C are sectional views taken along line A-A in the sensor main body in FIGS. 5A and 5B;

FIGS. 9A and 9B are diagrams showing structures of the proximity sensor apparatus in FIG. 1;

FIG. 10 is a diagram showing another wire wiring of the detection electrode in FIG. 6;

FIG. 11 is a diagram showing a structure of a proximity sensor apparatus for discriminating approaching directions by multi-channeling the wire wiring in FIG. 10; and

FIG. 12 is a view showing an example in which the wire of the detection electrode in FIG. 6 is wired in a spiral shape in accordance with an outer surface of a target section.

### DETAILED DESCRIPTION

Hereinafter, a proximity sensor apparatus according to a present embodiment will be described with reference to the accompanying drawings. In the following explanation, a robot arm mechanism including the proximity sensor apparatus according to the present embodiment will be described as an example. In the robot arm mechanism, one joint of a plurality of joints is constituted of a linear extension and retraction mechanism. Note that one of features of the proximity sensor apparatus according to the present embodiment lies in that a detection electrode thereof is formed by a conductive wire. This enhances the degrees of freedom of wiring of the detection electrode, and realizes implementation of the electrode to a complicated structure. Consequently the proximity sensor apparatus according to the present embodiment may be mounted to structures other than the robot arm mechanism, for example, an automobile and the like. In the following description, the same reference numerals denote components having substantially identical functions and structures, and the repeated description thereof is made only when necessary.

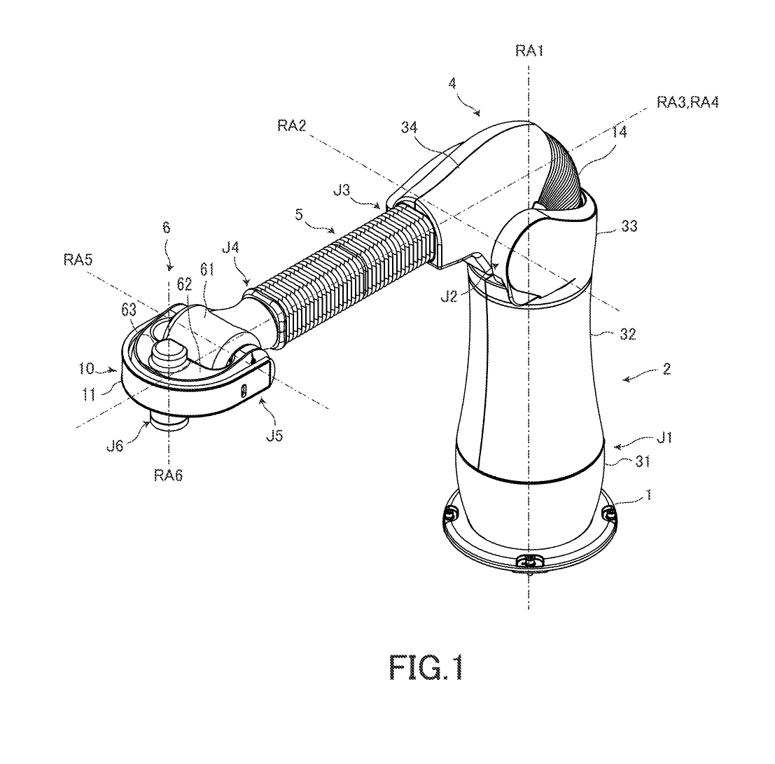

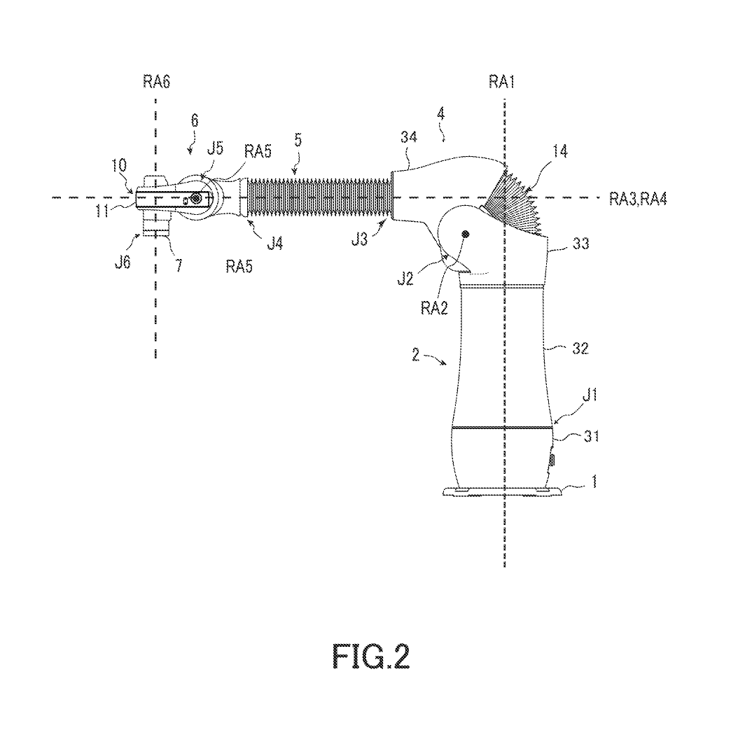

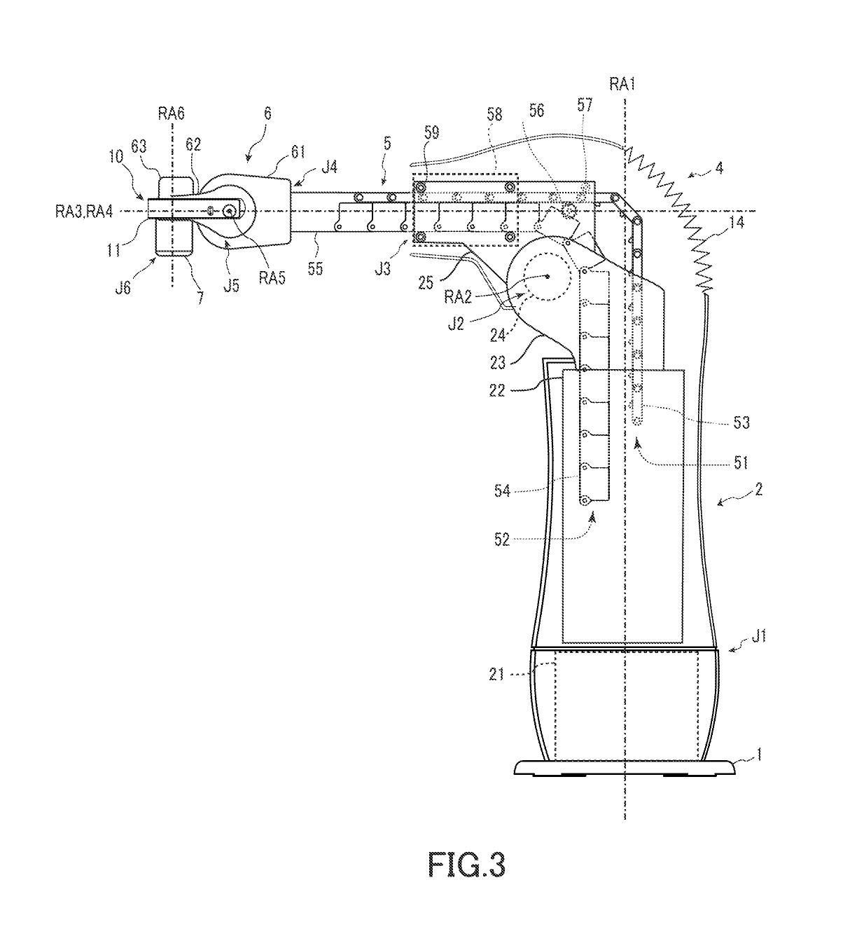

FIG. 1 illustrates an external view of a robot arm mechanism equipped with a proximity sensor apparatus 10 according to the present embodiment. FIG. 2 is a side view of the robot arm mechanism in FIG. 1. FIG. 3 is a side view illustrating an internal structure of the robot arm mechanism in FIG. 1.

The robot arm mechanism includes a base 1, a turning section (support section) 2, a rising and lowering section 4, an arm section 5 and a wrist section 6. The turning section 2, the rising and lowering section 4, the arm section 5 and the wrist section 6 are arranged in order from the base 1. A plurality of joints J1, J2, J3, J4, J5 and J6 are arranged in order from the base 1. The turning section 2 which forms a cylindrical body is typically installed vertically on the base 1. The turning section 2 houses the first joint J1 as a turning rotation joint. The first joint. J1 includes an axis of torsional rotation RA1. The axis of rotation RA1 is parallel to a vertical direction. The turning section 2 has a lower frame 21 and an upper frame 22. One end of the lower frame 21 is connected to a fixed section of the first joint. J1. The other end of the lower frame 21 is connected to the base 1. The lower frame 21 is covered with a housing 31 in a cylinder shape. The upper frame 22 is connected to a rotating section of the first joint J1, and axially rotates on the axis of rotation RA1. The upper frame 22 is covered with a housing 32 in a cylinder shape. The upper frame 22 rotates with respect to the lower frame 21 in accordance with the rotation of the first joint J1, and thereby the arm section 5 turns horizontally. In an internal hollow of the turning section 2 forming the cylindrical body, a first and second piece strings 51 and 52 of the third joint J3 as a linear extension and retraction mechanism that will be described later are housed.

The rising and lowering section 4 that houses the second joint J2 as a rising and lowering rotation joint is installed on an upper part of the turning section 2. The second joint J2 is a bending rotation joint. An axis of rotation RA2 of the second joint J2 is perpendicular to the axis of rotation RA1. The rising and lowering section 4 has a pair of side frames 23 as a fixed section (support body) of the second joint J2. The pair of side frames 23 are connected to the upper frame 22. The pair of side frames 23 are covered with a cover 33 in a saddle shape. A cylindrical body 24 as a rotating section of the second joint. J2, which is also used as a motor housing, is supported by the pair of side frames 23. A sending-out mechanism 25 is attached to a circumferential surface of the cylindrical body 24. The sending-out mechanism 25 is covered with a cover 34 in a cylinder shape. A gap between the saddle-shaped cover 33 and the cylindrical cover 34 is covered with a U-shaped pleated cover 14 having a U-shaped section. The U-shaped pleated cover 14 extends and retracts by following rising and lowering motions of the second joint 42.

The sending-out mechanism 25 holds a drive gear 56, a guide roller 57 and a roller unit 58. The sending-out mechanism 25 rotates in accordance with the axial rotation of the cylindrical body 24, and the arm section 5 supported by the sending-out mechanism 25 rises and lowers up and down.

The third joint. J3 is provided by the linear extension and retraction mechanism. The linear extension and retraction mechanism includes a structure that is newly developed by the inventors, and is clearly distinguished from a so-called conventional linear motion joint from the viewpoint of a movable range. The arm section 5 of the third joint J3 is bendable, but when the arm section 5 is sent out forward from the sending-out mechanism 25 at a root of the arm section 5 along a center axis (center axis of extension and retraction RA3), bending of the arm section 5 is restricted, and linear rigidity is ensured. When the arm section 5 is pulled backward, bending is restored. The arm section 5 has the first piece string 51 and the second piece string 52. The first piece string 51 is constituted of a plurality of first pieces 53 that are connected to be bendable. The first piece 53 is formed into a substantially flat-plate shape. The first pieces 53 are bendably connected with hinge sections in spots at end portions. The second piece string 52 is constituted of a plurality of second pieces 54. The second piece 54 is formed into a groove-shaped body with a U-shaped cross section or a tubular body with a hollow-square-shaped cross section. The second pieces 54 are bendably connected with hinge sections in spots at bottom plate end portions. Bending of the second piece string 52 is restricted in a position where end surfaces of side plates of the second pieces 54 abut on one another. In that position, the second piece string 52 is arranged linearly. The leading first piece 53 of the first piece string 51 and the leading second piece 54 of the second piece string 52 are connected by a head piece 55. For example, the head piece 55 has a shape obtained by combining the first piece 53 and the second piece 54.

The first and second piece strings 51 and 52 are pressed against each other and overlapped with each other by a roller 59 when the first and second piece strings 51 and 52 pass through the roller unit 58 of the sending-out mechanism 25. By being overlapped with each other, the first and second piece strings 51 and 52 exhibit linear rigidity, and constitute the columnar arm section 5. Behind the roller unit 58, the drive gear 56 is disposed with the guide roller 57. The drive gear 56 is connected to a motor unit not illustrated. The motor unit generates power for rotating the drive gear 56. As will be described later, a linear gear is formed along a connection direction, in a center of a width of an inner surface of the first piece 53, that is, a surface at a side where the first piece 53 is overlapped with the second piece 54. Linear gears that are adjacent to one another when the plurality of first pieces 53 are aligned linearly are connected to one another linearly, and constitute a long linear gear. The drive gear 56 is engaged with the linear gear of the first piece 53 which is pressed by the guide roller 57. The linear gears which are connected linearly constitute a rack and pinion mechanism with the drive gear 56. When the drive gear 56 rotates forward, the first and second piece strings 51 and 52 are sent out forward from the roller unit 58. When the drive gear 56 rotates backward, the first and second piece strings 51 and 52 are pulled backward of the roller unit 58. The first and second piece strings 51 and 52 which are pulled back are separated from each other between the roller unit 58 and the drive gear 56. The first and second piece strings 51 and 52 which are separated respectively return to bendable states. The first and second piece strings 51 and 52 which return to bendable states both bend in a same direction (inward), and are vertically housed in the turning section 2. At this time, the first piece string 51 is housed in a state in which the first piece string 51 is substantially aligned substantially parallel to the second piece string 52.

The wrist section 6 is attached to a tip of the arm section 5. The wrist section 6 is equipped with fourth to sixth joints J4 to J6. The fourth to sixth joints J4 to J6 respectively include axes of rotation RA4 to RA6 which are orthogonal three axes. The fourth joint J4 is a torsional rotation joint that rotates on the fourth axis of rotation RA4 which substantially matches the center axis of extension and retraction RA3, and by rotation of the fourth joint J4, an end effector is swingably rotated. The fifth joint J5 is a bending rotation joint that rotates on the fifth axis of rotation RA5 disposed perpendicularly to the fourth axis of rotation RA4, and by rotation of the fifth joint J5, the end effector is pivoted forward and backward. The sixth joint J6 is a torsional rotation joint that rotates on the sixth axis of rotation RA6 disposed perpendicularly to the fourth axis of rotation RA4 and the fifth axis of rotation RA5, and the end effector is axially rotated by rotation of the sixth joint J6.

The fourth joint J4 forms a cylindrical body with the axis of rotation RA4 as a center line, and a fixed section 61 of the fifth joint J5 which forms a cylindrical body is attached to a tip of the fourth joint J4 so that the cylindrical body of the fourth joint J4 and a center line are orthogonal to each other. An arm 62 in a U-shape or C-shape is rotatably supported at the fixed section 61 of the fifth joint J5 in a state in which the arm 62 is placed across both ends of the fixed section 61. A cylindrical body 63 that forms the fixed section of the sixth joint J6 is attached to an inside of a tip of the arm 62.

A sensor main body 11 of a proximity sensor apparatus 10 that is typically in a U-shape is mounted to the arm 62 in the U-shape of the wrist section 6 in such a manner as to cover an outer circumference of the arm 62. Note that it is not denied that the sensor main body 11 is in a C-shape. When an object to be detected which is typically a finger, an arm, a body or the like of a worker (human being) approaches the sensor main body 11 of the proximity sensor apparatus 10, the proximity sensor apparatus 10 detects the approach. Details of the proximity sensor apparatus 10 will be described later.

The end effector is attached to an adapter 7 provided at a lower part of a rotating section of the sixth joint. J6 of the wrist section 6. The end effector is a section having a function of directly acting on an object to be worked (a work) by a robot, and various tools exist in accordance with tasks, such as a holding section, a vacuum suction section, a nut fastening tool, a welding gun, and a spray gun, for example. The end effector is moved to a given position by the first, second and third joints J1, J2 and J3, and is placed in a given posture by the fourth, fifth and sixth joints J4, J5 and J6. In particular, a length of an extension and retraction distance of the arm section 5 of the third joint J3 enables the end effector to reach an object in a wide range from a position close to the base 1 to a position far from the base 1. In the third joint J3, the linear extension and retraction motions and the length of the extension and retraction distance realized by the linear extension and retraction mechanism constituting the third joint J3 are characteristics that differ from the conventional linear motion joint.

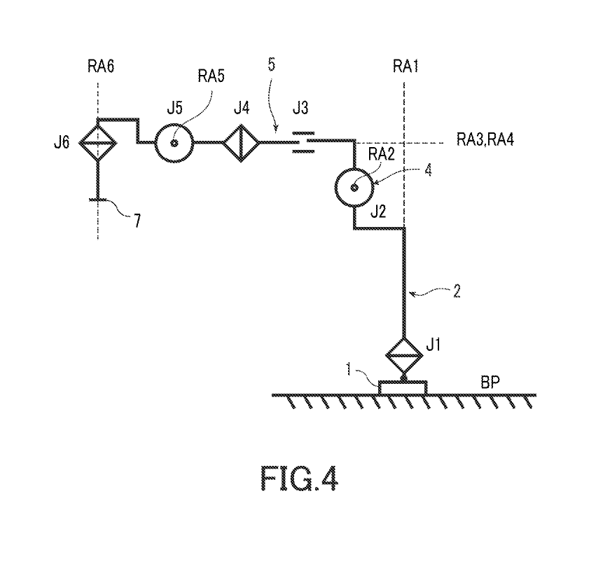

FIG. 4 shows the structure of the robot arm mechanism by graphic symbol expression. In the robot arm mechanism, three degrees of freedom of position are realized by the first joint J1, the second joint J2 and the third joint J3 that constitute root three axes. Further, three degrees of freedom of posture are realized by the fourth joint J4, the fifth joint. J5 and the sixth joint J6 that constitute wrist three axes. As illustrated in FIG. 4, the axis of rotation RA1 of the first joint J1 is provided in a vertical direction. The axis of rotation RA2 of the second joint J2 is provided in a horizontal direction. The second joint J2 is offset with respect to two directions that are the axis of rotation RA1 and an axis orthogonal to the axis of rotation RA1 with respect to the first joint J1. The axis of rotation RA2 of the second joint. J2 does not intersect the axis of rotation RA1 of the first joint J1. The axis of movement RA3 of the third joint J3 is provided in a perpendicular direction with respect to the axis of rotation RA2. The third joint J3 is offset with respect to two directions that are the axis of rotation RA1 and an axis orthogonal to the axis of rotation RA1 with respect to the second joint J2. The axis of rotation RA3 of the third joint J3 does not intersect the axis of rotation RA2 of the second joint. J2. One bending joint of the root three axes of the plurality of joints J1 to J6 is replaced with the linear extension and retraction joint J3, the second joint. J2 is offset to the two directions with respect to the first joint J1, and the third joint J3 is offset to the two directions with respect to the second joint J2, whereby the robot arm mechanism of the robot apparatus according to the present embodiment structurally eliminates a singularity posture.

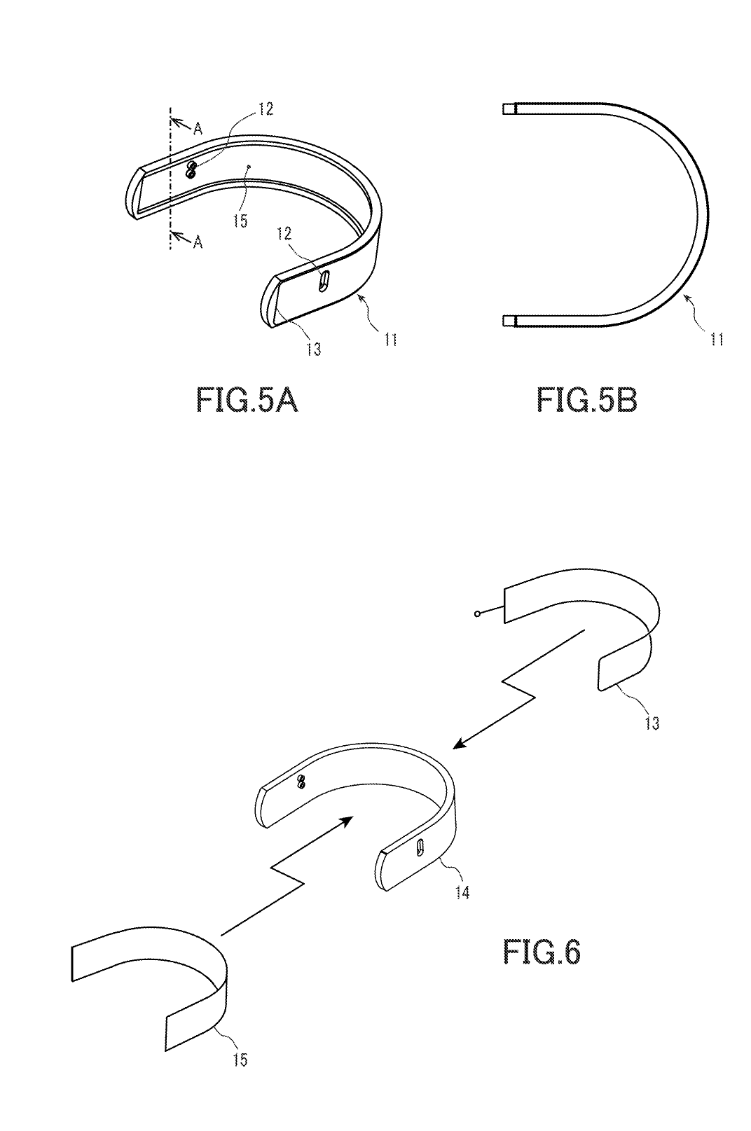

FIG. 5A is a perspective view of the sensor main body 11 of the proximity sensor apparatus 10, and FIG. 5B is a plan view of the sensor main body 11. FIG. 6 shows a structure of the sensor main body 11. As the proximity sensor apparatus 10, an electrostatic-capacitance-type proximity sensor apparatus is adopted, which detects approach of an object to be detected to the sensor main body 11 based on a change in an electrostatic capacitance which occurs by the approach of the object to be detected which is a grounded conductor such as a body, an arm, or a finger of a worker, to the sensor main body 11. The sensor main body 11 is a thin plate-shaped body that is curved into a U-shape. The sensor main body 11 may be in a C-shape. A screw hole 12 for being fitted to the arm 62 in the U-shape of the wrist section 6 is provided at each of both ends of the sensor main body 11. The sensor main body 11 has a base 14 as a plate-shaped body that is formed into a U-shape from a non-conductive material as a nonconductor (insulator) of a resin or the like. A detection electrode 13 as a conductor that is curved into a U-shape along a front surface shape of the base 14 is fitted to a front surface of the base 14. A shield plate (guard) 15 having conductivity is fitted to a back surface of the base 14, as a conductive plate that is curved into a U-shape along a back surface shape of the base 14 in order to eliminate erroneous detection of a change in the electrostatic capacitance due to movement or the like of the grounded conductor on a back surface side thereof.

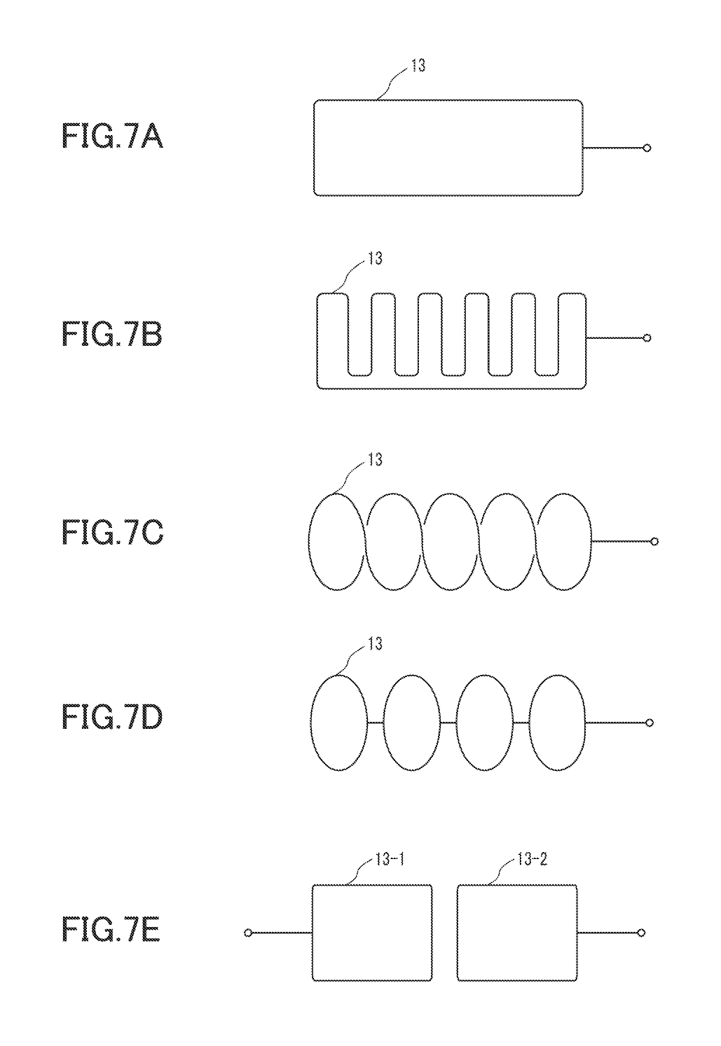

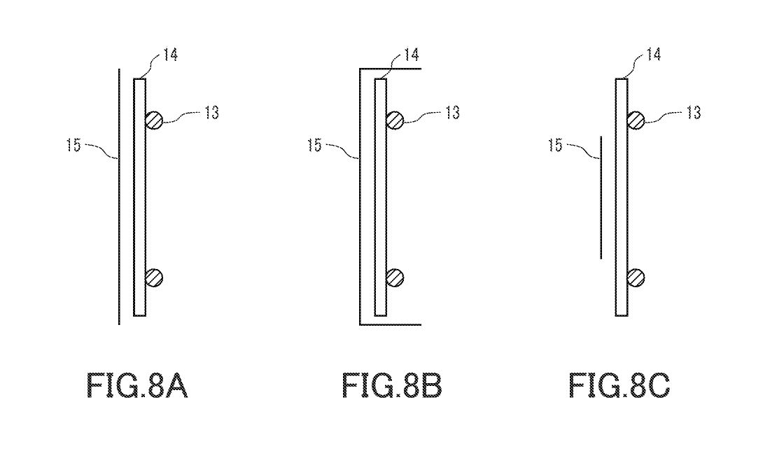

As shown in FIG. 7A, the detection electrode 13 is constituted of wiring of a conductive wire to realize a lighter weight than the conducive plate. The wire 13 is circumferentially provided on the front surface of the base 14 along an outer edge thereof. A wiring shape of the wire 13 typically forms a rectangle in which long axes are curved. A detection distance is, for example, in a range of 1 to 3 cm. Depending on a short axis length of the rectangle, a valley of a sensitivity region may occur in a short axis direction thereof. In order to reduce the valley of the sensitivity region, the wire 13 may be wired on the front surface of the base 14 in a wavy pattern that reciprocates throughout an entire width region of the front surface, as shown in FIG. 7B. Further, as shown in FIG. 7C, the wire 13 may be wired on the front surface of the base 14 to draw a continuous repetition of a twisted shape, that is, figure 8. Further, as shown in FIG. 7D, the wire 13 may be wired on the front surface of the base 14 to form connected circles.

As further shown in FIG. 7E, a plurality of wires 13-1 and 13-2 that are wired into rectangular shapes respectively may be arranged in a U-shape. The wire 13-1 on one side is separated and wired on a left, side of the front surface of the base 14, and the wire 13-2 on the other side is separated and wired on a right side of the front surface of the base 14, respectively.

FIG. 8 is a sectional view taken along line A-A in FIGS. 5A and 5B. As shown in FIG. 8A, a width of the guard 15 is longer than the short axis of the wire 13 which is wired in the rectangular shape, and a length of the guard 15 is equivalent to or longer than the long axis of the wire 13 so that the guard 15 on the back surface of the base 14 typically covers an entire back surface of the wire 13 which is wired in the rectangular shape. As shown in FIG. 8B, the guard 15 may be formed to have a U-shaped cross section to cover the entire back surface of the wire 13 which is wired into the rectangular shape, and also side surfaces of the wire 13, so that sensitivity concentrates in a front part of the wire 13. Further, as shown in FIG. 8C, the width of the guard 15 may be shorter than the short axis length of the rectangle of the wire 13 so that the wire 13 has the sensitivity in the front part thereof, and has sensitivity more broadly than the case of FIG. 8A in side parts.

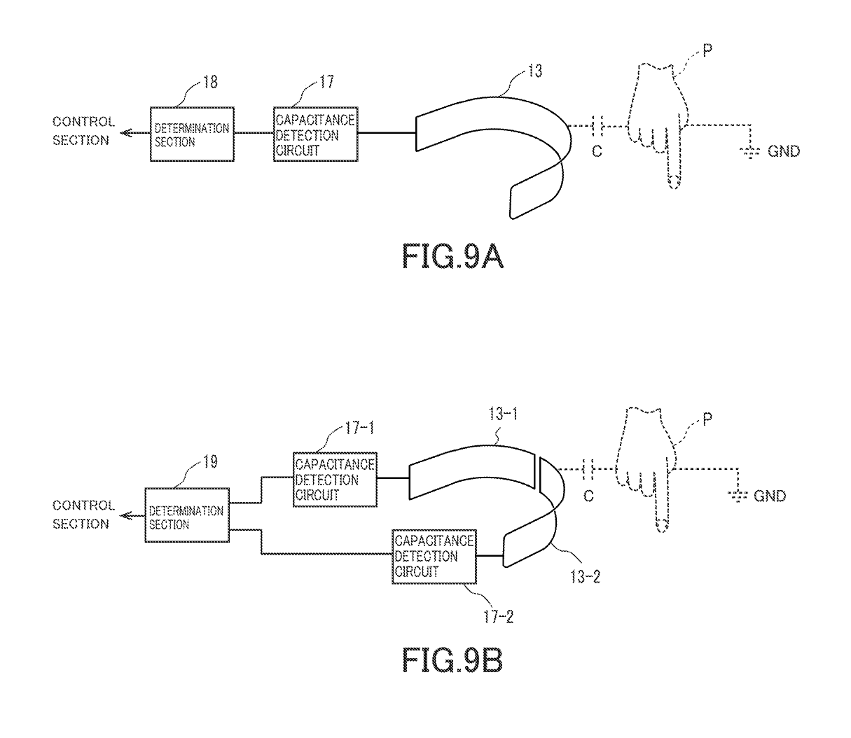

As shown in FIG. 9A, a capacitance detection circuit 17 detects an electrostatic capacitance (capacitance to ground) C that is formed between an object to be detected P as the grounded conductor such as a finger of a worker which approaches, and the detection electrode 13. The capacitance detection circuit 17 detects the electrostatic capacitance C by a switched capacitor operation. A determination section 18 determines approach of the object to be detected P to the detection electrode 13 from the change in the electrostatic capacitance C which is detected by the capacitance detection circuit 17. The electrostatic capacitance C is small in a state in which the object to be detected P does not exist in a sensitivity region, and increases in a state in which the object to be detected P exists in the sensitivity region. The determination section 18 determines the approach of the object to be detected P by the electrostatic capacitance C having a predetermined value or more. A determination result of the determination section 18 is sent to a control section of a robot apparatus, for example, and is used in emergency stop control, for example. As the emergency stop control, the robot apparatus may be stopped in control, or various kinds of stop control are adopted such as stopping the robot apparatus after decelerating the robot apparatus to a predetermined speed for only a predetermined time period.

When a plurality of, for example, the two wires 13-1 and 13-2 that are respectively wired in rectangular shapes and electrically separated from each other are arranged in the U-shape as shown in FIG. 7E, the capacitance detection circuits 17-1 and 17-2 are individually connected to the wires 13-1 and 13-2 to detect capacitances individually, and a determination section 19 can discriminate which one of the wires 13-1 and 13-2 the object to be detected P approaches in accordance with a detection result thereof, as shown in FIG. 9B. That is, it can be determined from which direction of left and right directions the object to be detected P approaches the wire with two channels, and it becomes possible to cause the wrist section 6 to perform a so-called retraction operation of moving by a very small distance in a direction to separate from the object to be detected, for example, when approach of the object to be detected is detected in the control section.

In this way, the sensor main body of the proximity sensor apparatus according to the present embodiment includes the detection electrode in a U-shape, and therefore the sensor main body can have sensitivity to approaches from many directions of not only a front but also a left or right to the detection electrode. The proximity sensor apparatus can be realized with a very simple structure as compared with the conventional structure in which a number of sensor apparatuses, at least a number of detection electrodes are mounted to the wrist section and the like while the positions and directions are changed. In addition, in the present embodiment, the detection electrode is implemented with wiring of the wire, and simplification of the structure, reduction in the number of assembly steps, and reduction in weight of the sensor main body can be realized. Further, it is not necessary to provide capacitance detection circuits and the determination sections individually to a number of detection electrodes as in the conventional sensor apparatus, and approaches from many directions can be detected with the capacitance detection circuit and the determination section of one system.

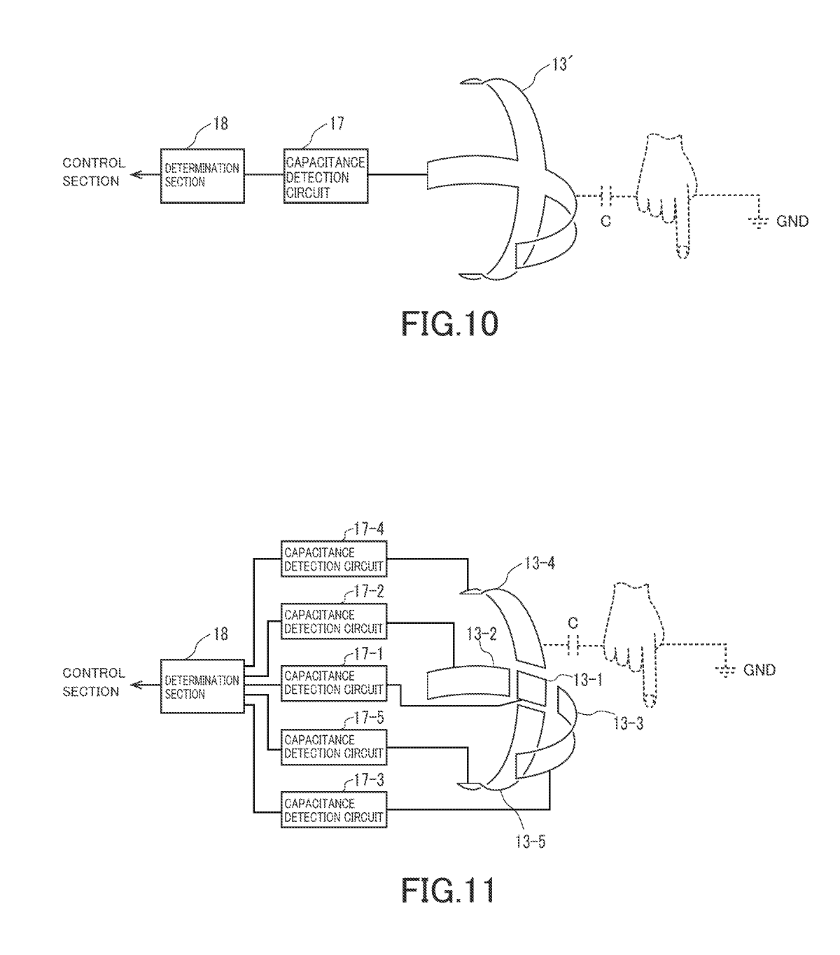

In the above, the detection electrode can have sensitivity to approaches in the three directions in total that are the front and both left and right sides by wiring the wire into a U-shape or a C-shape. However, as illustrated in FIG. 10, the wire is wired in a cross shape, and is curved into a U-shape or a C-shape with respect to each of a horizontal part and a vertical part, whereby the detection electrode may be given sensitivity to approaches in five directions in total that are a front, and a left and right, to which an up and down are further added.

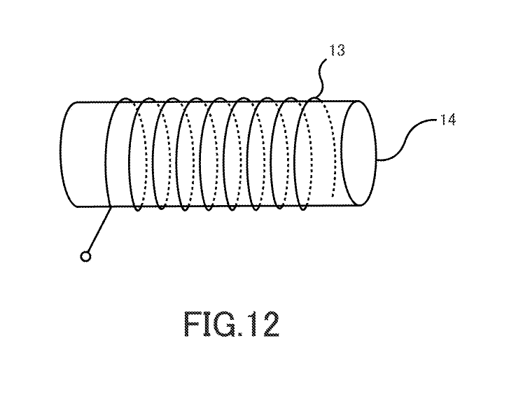

Further, as illustrated in FIG. 11, the wire which is wired in the cross shape illustrated in FIG. 10 is divided into a plurality of sections, a front wire 13-1, left and right wires 13-2 and 13-3, and upper and lower wires 13-4 and 13-5 are provided, these wires are electrically separated, and respective electrostatic capacitance changes are individually detected by capacitance detection circuits 17-1 to 17-5, whereby approaches in five directions in total that are the front, the left and right and the up and down can be distinguished and detected. The determination section 18 can distinguish approaches in the five directions and can output approach signals. That is, the proximity sensor apparatus can be made multi-channeled, five-channeled in the example in FIG. 11. The control section which is supplied with five-channeled approach signals can cause retraction operations to be performed individually to the five directions as described above. Further, the control section can apply joint operation control using an approach signal with the approaches in the five directions distinguished to direct teaching control. For example, when the worker causes his or her own hand to approach the proximity sensor main body 11 from a certain direction, the control section excludes (gives a zero value to) a movement component in the direction in which the worker causes his or her hand to approach from movement components in the five directions at the maximum of the wrist section 6 at this time, and allows movement components concerning remaining directions to continue, and thereby the worker can teach a desired track while guiding the wrist section 6 with his or her hand without operating a remote controller or the like.

Further, one of the important features of the detection electrode 13 is that the detection electrode 13 is constituted of a conductive wire. A conductive wire has a higher degree of freedom of a shape thereof than a plate-shaped or a foil electrode. Accordingly, it is possible to wire the conductive wire by winding the conductive wire in a spiral shape around an outer circumference of various structures that are concerned about contact with an outside, for example, an arm 14 as illustrated in FIG. 12, and it is also possible to curve the conductive wire arbitrarily along a complicated outer shape of the robot arm mechanism, and wire the conductive wire on an outer surface of the robot arm mechanism.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

### REFERENCE SIGNS LIST

10 . . . Proximity sensor apparatus, 11 . . . Sensor main body, 13 . . . Detection electrode, 14 . . . Base, 15 . . . Guard

1. A proximity sensor apparatus comprising:
a detection electrode that forms an electrostatic capacitance between the detection electrode and an object to be detected that approaches the detection electrode section;
a detection section that detects the electrostatic capacitance; and
a determination section that determines approach of the object to be detected to the detection electrode based on the detected electrostatic capacitance,
wherein the detection electrode includes
a base plate that curves into a U-shape or a C-shape,
a detection electrode that is disposed on a front surface of the base plate, and curves along the front surface of the base, and
a guard plate that is disposed on a back surface of the base plate, and curves along the back surface of the base.

2. The proximity sensor apparatus according to claim 1,
wherein the detection electrode is constituted by wiring of a conductive wire.

3. The proximity sensor apparatus according to claim 2,
wherein the wire is wired in a rectangular shape on the front surface of the base along an outer edge of the front surface.

4. The proximity sensor apparatus according to claim 2,
wherein the wire is wired in a wavy pattern reciprocating in a width direction of the front surface of the base on the front surface of the base.

5. The proximity sensor apparatus according to claim 2,
wherein the wire is wired in a shape of figure 8 on the front surface of the base.

6. The proximity sensor apparatus according to claim 2,
wherein the wire is wired on the front surface of the base to form connected circles.

7. The proximity sensor apparatus according to claim 1,
wherein the guard has a wider width than the detection electrode.

8. The proximity sensor apparatus according to claim 1,
wherein the guard has a U-shaped cross section to cover a back surface and side surfaces of the detection electrode.

9. The proximity sensor apparatus according to claim 1,
wherein the guard has a narrower width than the detection electrode.

10. A proximity sensor apparatus comprising:
a detection electrode that forms an electrostatic capacitance between the detection electrode and an object to be detected that approaches the detection electrode section;
a detection section that detects the electrostatic capacitance; and
a determination section that determines approach of the object to be detected to the detection electrode based on the detected electrostatic capacitance,
wherein the detection electrode includes
a base plate,
a detection electrode that is constituted of a conductive wire that is disposed on a front surface of the base plate, and
a guard that is disposed on a back surface of the base plate.

11. A robot arm mechanism in which a support section including a turning rotation joint is supported on a base, a rising and lowering section including a rising and lowering rotation joint is placed on the support section, a linear extension and retraction mechanism including an arm section with linear extension and retraction properties is provided at the rising and lowering section, and a wrist section to which an end effector can be fitted is mounted to a tip of the arm section,
wherein a proximity sensor apparatus is mounted to the wrist section,
the proximity sensor apparatus comprises
a detection electrode that forms an electrostatic capacitance between the detection electrode and an object to be detected that approaches the detection electrode section;
a detection section that detects the electrostatic capacitance; and
a determination section that determines approach of the object to be detected to the detection electrode based on the detected electrostatic capacitance,
wherein the detection electrode includes
a base plate that curves into a U-shape or a C-shape,
a detection electrode that is disposed on a front surface of the base plate, and curves along the front surface of the base, and
a guard plate that is disposed on a back surface of the base plate, and curves along the back surface of the base.
